(19) United States
(12) Patent Application Publication
(10) Pub. No.: US 2025/0106730 A1
(43) Pub. Date: Mar. 27, 2025

(54) ROUTE DISCOVERY AND MANAGEMENT BY COMMUNICATION SERVICES PLATFORM

(71) Applicant: Twilio Inc., San Francisco, CA (US)

(72) Inventors: Henrik Kotkas, Tallinn (EE); Oleksandr Drozd, Tallinn (EE); Nariman Nazari, Malmo (SE)

(21) Appl. No.: 18/371,801

(22) Filed: Sep. 22, 2023

(51) Int. Cl. H04W 40/24; H04W 40/02

(52) U.S. Cl. CPC H04W 40/246; H04W 40/02

(57) ABSTRACT

An example method of route discovery and management includes: discovering a new route for forwarding messages to a specified destination network; responsive to determining that the new route satisfies one or more performance criteria, appending a definition of the new route to a route registry associated with the specified destination network; selecting, from the route registry, one or more routes matching a specified route profile, wherein the one or more routes comprise the new route; and determining, using the one or more routes, an allocation of outgoing messages to message routing providers.

### TECHNICAL FIELD

Aspects and implementations of the disclosure relate to computer networking, and more specifically, to systems and methods for automated route discovery and management by a communication services platform.

### BACKGROUND

Instant messaging (IM) technology allows real-time transmission of media content over the Internet or another packet switched network. Sender-originated messages may be transmitted to one or more recipients, which may be connected to a destination network via a common application. Short Messaging Service (SMS) technology provides text messaging, i.e., sending an SMS message to one or more mobile client devices over a cellular data network. Multimedia Messaging Service (MMS) technology provides a way to send messages that include multimedia content to one or more mobile client devices over a cellular data network.

### BRIEF DESCRIPTION OF THE DRAWINGS

Aspects and implementations of the disclosure will be understood more fully from the detailed description given below and from the accompanying drawings of various aspects and implementations of the disclosure, which, however, should not be taken to limit the disclosure to the specific aspects or implementations, but are for explanation and understanding.

FIG. 1 illustrates an example system architecture of a communication services platform, in accordance with aspects of the disclosure.

FIG. 2 is a flow diagram of an example method of route discovery and management, in accordance with aspects of the present disclosure.

FIG. 3 is a flow diagram of an example method of route discovery, in accordance with aspects of the present disclosure.

FIG. 4 schematically illustrates an example graphical user interface (GUI) that may be implemented by a provider-facing route registration portal, implemented in accordance with one or more aspects of the present disclosure.

FIG. 5 is a block diagram illustrating an exemplary computer system, in accordance with some implementations of the disclosure.

### DETAILED DESCRIPTION

Various organizations have been increasingly adopting messaging as a valuable tool for communications within and outside of the organization. In an example use case, an organization may use messaging to forward to client devices of its end users one-time passwords for a two-factor authentication scheme. In another example use case, an organization may use messaging to send promotional messages to client devices of its end users. In yet another example use case, an organization may use messaging to send appointment reminders to client devices of its end users and may further request the message receiver to reply to either confirm or cancel an appointment.

In these and various other use cases, organizations may employ communication services platforms, such as Software as a Service (SaaS) platforms, which facilitate sending of messages (such as SMS messages, MMS messages, and/or IM messages) generated by multiple message originating entities (“customers” of the communication services platform) to recipient devices via multiple message routing providers.

The communication services platform may employ one or more message routing providers for delivering messages to their respective destinations on respective destination networks. Each message routing provider may implement one or more routes to each of the destination networks served by that message routing provider. Each route may employ a specific set of communication technologies, networks, and/or configurations (e.g., characterized by a set of parameters, including the number of hops, deliverability, latency, throughput, pricing model, etc.). Some of those parameters (e.g., those characterizing deliverability and latency) may be directly or indirectly measurable by the communication services platform (e.g., based on the validation and testing procedures performed by the communication services platform and/or on the feedback provided by customers of the communication services platform).

Conversely, each customer of a communication services platform may have a respective set of message routing requirements (e.g., defined by the cost, latency, message conversion rate, and/or other parameters). “Message conversion rate” reflects the likelihood of successful message delivery to its intended recipient and may be represented by the share of the messages that were successfully delivered (i.e., the ratio of the number of delivered messages to the number of forwarded messages). “Cost” herein shall broadly refer to an amount of resources that are consumed by the message delivery. In an illustrative example, the cost of message delivery may be measured by a monetary amount charged for the message delivery by the message routing provider. In an illustrative example, the cost of message delivery may reflect (i.e., may be derived by applying a chosen mathematical transformation to) the amount of computing resources (e.g., memory size, processing power, number of virtual machines, etc.) that are consumed by the message delivery. In other illustrative examples, the cost of message delivery may reflect the above-described and various other metrics.

Thus, in order to meet the customers' message routing optimization requirements, the communication services platform may need to dynamically allocate customer-originating messages to available routes to a specified destination network. However, manual discovery and management of available routes would be error-prone and unfeasible due to a large number of destinations served by the communications services platform.

Systems and methods implemented in accordance with aspects of the present disclosure perform automated route discovery, validation, testing, and management, thus facilitating fully automated route allocation to customer-originated messaging traffic.

In some implementations, the communication services platform may support, for each served destination, one or more route profiles. A route profile may include a set of requirements which a route should satisfy in order to match the profile, which may be associated, e.g., with a use case. The set of requirements may include, e.g., route capabilities (e.g., SMS delivery), threshold parameter values (such as the maximum number of hops) and/or performance or quality metric thresholds (such as deliverability, latency, throughput, etc.).

Accordingly, the communication services platform may maintain, for each destination, at least a predefined number of active routes matching each route profile. Responsive to determining that the number of active routes matching a certain route profile for a particular destination fails below a predefined threshold number of routes, an active route discovery process may be initiated, which involves transmitting a route discovery request to one or more message routing providers. A route discovery request may specify the desired capabilities and parameters of the route (e.g., destination, deliverability, latency, throughput, etc.).

In various illustrative examples, route discovery may be triggered automatically or responsive to receiving a command via a user interface (UI). Automated triggering of route discovery may be performed, e.g., periodically and/or when the existing routes are failing to meet the customers objective(s) in one or more aspects, such as deliverability, latency, throughput, etc. In some implementations, route discovery may be facilitated by a provider-facing route registration API and/or a provider-facing route registration portal, through which message routing providers may communicate the route capabilities and/or parameters to the communication services platform, as described in more detail herein below.

The newly discovered routes may undergo automated validation and testing in order to confirm the route capabilities and/or estimate various route parameters characterizing deliverability, latency, throughput, etc. Example parameters that may be evaluated by automated validation and testing include: error rates for data submissions to the message routing provider servicing the route, for acknowledgements of such data submissions, or for both, latencies for data submissions to the message routing provider servicing the route, for acknowledgements of such data submissions, or for both, error rates for delivery receipts from the message routing provider servicing the route, and/or latencies for such delivery receipts.

The validation and testing procedure may be also implemented with respect to existing routes (e.g., periodically or upon receiving, from other functional modules of the communication services platform, a notification of deteriorating parameters of a given route). Upon completing the validation and testing, the newly discovered routes together with their respective capabilities and parameters may be recorded in the route registry maintained by the communication services platform, as described in more detail herein below.

Accordingly, the communication services platform may select, for routing messages initiated by a particular customer, a destination-specific combination of one or more routes matching suitable route profile(s) and meeting the customer's message routing requirements, as described in more detail herein below.

Furthermore, in some implementations, validation and testing of an existing route may indicate that some of the route parameters have deteriorated below their respective acceptable threshold values (e.g., specified by the route profile associated with the existing route being tested), in which case the communication service platform may notify the message routing provider servicing the route of the deteriorated parameter values.

Besides, in come implementations, the communication services platform may notify, via the provider-facing route registration API and/or the provider-facing route registration portal, a message routing provider of desired threshold values of one or more route parameters for one or more routes served by that message routing provider, as described in more detail herein below.

Thus, the present disclosure addresses the technical problem of message routing under customer-specified constraints. A technical solution to the above-identified technical problem involves automated route discovery, testing, and validation, in order to maintain a registry of routes which are then used for allocating message traffic to message routing providers.

Another technical solution to the above-identified technical problem involves automatically notifying the message routing providers of desired capabilities and/or parameters of routes to specified destination networks.

Thus, the technical effect includes implementing an end-to-end message forwarding environment in which communications between the communication services platform and message routing providers are facilitated by a provider-facing route registration API and/or a provider-facing route registration portal, thus allowing automated route discovery and management in order to maintain a registry of routes which are then used for allocating message traffic to message routing providers, as described in more detail herein below.

Various aspects of the methods and systems are described herein by way of examples, rather than by way of limitation. The systems and methods described herein may be implemented by hardware (e.g., general purpose and/or specialized processing devices, and/or other devices and associated circuitry), software (e.g., instructions executable by a processing device), or a combination thereof.

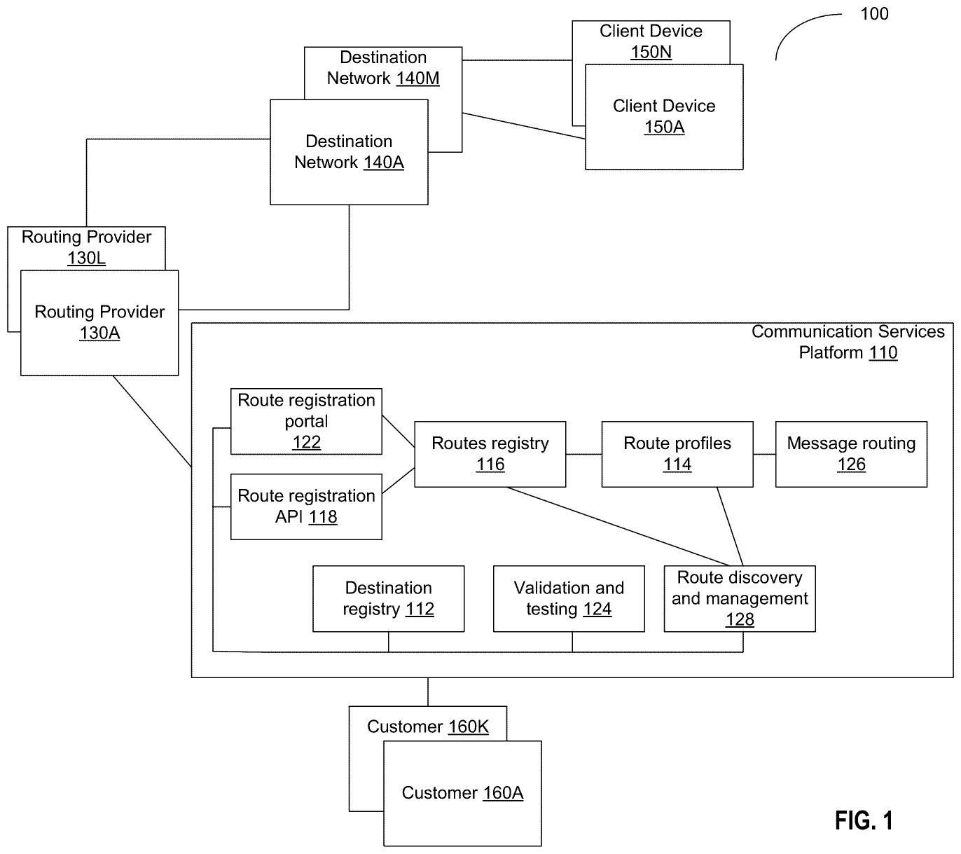

FIG. 1 illustrates an example distributed system architecture (“system”) 100 implemented in accordance with aspects of the present disclosure. The distributed system architecture 100 supports a communication services platform 110, which may be implemented by one or more general purpose or specialized computing devices (such as servers), data stores (e.g., hard disks, memories, databases), networks, other hardware components that are utilized to run one or more software services, such as message routing services, and various middleware and operating systems. The computing devices may be disposed in one or more physical locations, which may include geographically distributed physical locations.

In some implementations, communication services platform 110 may implement a Software as a Service (SaaS) platform that provides messaging services for forwarding messages (such as SMS messages, MMS messages, and/or IM messages) generated by multiple message-originating entities (e.g., customers 160A-160K of the communication services platform) to client devices 150A-150N via a pool of message routing providers 130A-130L servicing respective destination networks 140A-140M. In some implementations, the communication services platform 110 may further provide various other services, including voice services, electronic mail services, video services, and/or chat messaging services.

The communication services platform 110 may be accessed (e.g., via one or more application programming interface (API) endpoints) by customer computing devices 160A-160K via a communication network, which may include one or more public networks (e.g., the Internet) and/or private networks (e.g., a local area network (LAN) or wide area network (WAN)) utilizing various physical and datalink layer technologies, such as wired networks (e.g., Ethernet network), wireless networks (e.g., an 802.11 network or a Wi-Fi network), and/or cellular networks (e.g., a Long Term Evolution (LTE) network).

A customer computing device 160A-160K may be represented by a general purpose or specialized computing device implementing a server running one or more applications that utilize one or more messaging technologies (such as Short Message Service (SMS) or Multimedia Messaging Service (MMS)) for communicating with client applications running on client devices 150A-150N.

A client device 150A-150N may be represented by a general purpose or specialized computing device, such as a mobile communication device (e.g., a smartphone), a portable computer (PC), a wearable device (e.g., smart watch, smart glasses, etc.), a network-connected television set, a smart appliance (e.g., a video doorbell), etc. In some implementations, a client device 150 may run one or more client applications that communicate (e.g., using one or more messaging technologies) with one or more customer computing device 160A-160K. In various example use cases, a client application running on a client device 150 may be a web application or a standalone application implementing a graphical user interface (GUI).

In some implementations, an API endpoint exposed by the communication services platform 110 may be accessed via a resource identifier, such a universal resource identifier (URI). The API endpoint may receive requests and return responses from/to customers 160A-160K. In various implementations, the API endpoint may implement, e.g., a REST (Representational State Transfer) API, a GraphQL API, a SOAP (Simple Object Access Protocol) API accessible via HTTP (Hypertext Transfer Protocol)/HTTPS (Hypertext Transfer Protocol Secure) or other suitable application layer protocols.

In some implementations, the API endpoint may be used for initiating a messaging request that may include one or more destination identifiers (e.g., recipient phone numbers), the message content (e.g., text and/or multimedia content), and the origin identifier (e.g., a sender phone number). In some implementations, outgoing messages may be automatically assigned an origin identified that is associated with the customer account.

Message routing providers 130A-130L that are utilized by a given communication services platform may employ different communication technologies, networks, and/or configurations. In an illustrative example, each message routing provider 130 may route the incoming messages to specified destinations via one or more messaging gateways (e.g., SMS gateways). Accordingly, message routing providers 130A-130L may exhibit different values of one or more chosen quality and/or performance metrics. In an illustrative example, a performance metric may reflect an estimated likelihood of successful message delivery to the intended recipients. Furthermore, each message routing provider 130A-130L may have its own pricing model, which may be, e.g., a fixed price for routing a specified number of messages, volume-dependent price, time-of-day dependent price, and/or various combinations of these and other pricing models.

Conversely, each customer 160A-160K of the communication services platform 110 may choose its own traffic optimization objective, which may be expressed by a set of requirements, e.g., specifying the desired value of a chosen message routing metric and/or desired cost. In an illustrative example, the set of requirements may prescribe maximizing the likelihood of successful message delivery (e.g., characterized by the message conversion rate) while not exceeding a specified maximum cost.

In order to meet the customer requirements, the communication services platform 110 may dynamically allocate customer-originating messages to the available message routing providers for a specified destination network (e.g., identified by the Mobile Country Code (MCC) and Mobile Network Code (MNC)). The destination network identifier(s) may be derived from a specified destination phone number or other destination endpoint identifier.

In an illustrative example, the communication services platform 110 may identify, in the destination registry 112, a record mapping at least a part of the specified destination phone number to one or more corresponding destination networks (identified by respective pairs of MCC and MNC). The destination registry 112 may further maintain, for each destination network, a corresponding set of regulations, capabilities and parameter values associated with the destination network. In an illustrative examples, the information maintained by the destination registry 112 may include the sender identifier types supported, portability requirements, pre-registration requirements, encoding, delivery receipts (DLR), routing modes allowed, time limitations, etc.

In some implementations, the communication services platform may maintain, for each destination, at least a predefined number of active routes matching each route profile defined in the registry of route profiles 114. Each route profile may include a corresponding set of requirements which a route should satisfy in order to match the profile, which may be associated, e.g., with a use case. The set of requirements may include, e.g., route capabilities (e.g., SMS delivery), threshold parameter values (such as the maximum number of hops) and/or performance or quality metric thresholds (such as deliverability, latency, throughput, etc.). In an illustrative example, a standard route profile may only include routes that support a predefined set of capabilities (e.g., SMS and MMS forwarding). In another illustrative example, a basic route profile may include routes that only support a subset of capabilities (e.g., SMS forwarding). In yet another illustrative example, a direct route profile may only include verified direct (single hop) routes.

In some implementations, a route profile may further include the minimum number of providers servicing the routes associated with a particular profile. In some implementations, a route profile may further include the maximum cost of message forwarding over the routes associated with a particular profile.

The routes may be maintained by the route registry 116 which may, for each route, include a corresponding record storing the identifiers of capabilities of the route, the values of parameters of the route, an identifier of the message routing provider servicing the route, and references to one or more route profiles matching the route. In some implementations, the route registry 116 may support a graphical user interface (GUI) allowing to view, create, and/or modify routes for a specified destination, view and/or modify parameters of a specified route, etc. In some implementations, the GUI supported by the route registry 116 may allow comparing two or more specified routes. In some implementations, the GUI supported by the route registry 116 may allow triggering an ad-hoc testing of a specified route.

In various illustrative examples, route discovery may be managed by the route discovery and management module 128, which may utilize a provider-facing route registration API 118 and/or a provider-facing route registration portal 122, through which message routing providers may communicate the route capabilities and/or parameters to the communication services platform, as described in more detail herein below.

Furthermore, in some implementations, validation and testing of an existing route may indicate that some of the route parameters have deteriorated below their respective acceptable threshold values, in which case the communication service platform may notify the message routing provider servicing the route of the deteriorated parameter values.

Besides, in come implementations, the communication services platform may notify, via the provider-facing route registration API and/or the provider-facing route registration portal, a message routing provider of desired threshold values of one or more route parameters for one or more routes served by that message routing provider, as described in more detail herein below.

The newly discovered and/or existing routes may undergo automated validation and testing, by the validation and testing module 124, in order to confirm the route capabilities and/or estimate various route parameters, such as deliverability, latency, throughput, etc. Upon completing the validation and testing, the route capabilities and parameters may be recorded in the route registry 116.

Accordingly, the message routing module 126 may select, for routing messages initiated by a particular customer, a destination-specific combination of one or more routes matching suitable route profile(s) and meeting the customer's message routing requirements, as described in more detail herein below. In some implementations, the message routing module 126 may utilize the message delivery feedback provided by one or more platform customers in order to estimate one or more parameters characterizing message delivery.

In some implementations, the routing decisions may be made by the message routing module 126 of the communication services platform 110 by feeding, to one or more routing models, parameter values of one or more routes serving the specified destination. A routing model may distribute the customer-originated messages among the message routing providers in order to satisfy the customer-specific traffic optimization objective. In an illustrative example, a routing model may solve an optimization task minimizing the message delivery cost under given quality constraints (e.g., deliverability and/or latency message delivery). In an illustrative example, a routing model may solve an optimization task maximizing a chosen quality metric (e.g., deliverability) under given cost and/or quality constraints (e.g., latency of message delivery).

In some implementations, based on feedback received from the message routing module 126, route discovery and management module 128 may generate a route modification request with request to a particular route, which may then be transmitted to the message routing provider associated with that route. The route modification request may specify desired threshold values of respective one or more specified parameters of the route.

In an illustrative example, the route modification request may specify desired values of respective one or more deliverability parameters (e.g., message conversion rate), thus notifying the relevant messaging provider of potential issues with message deliverability.

In another illustrative example, the route modification request may specify desired values of respective one or more latency parameters (e.g., message enqueuing latency and/or message delivery latency), thus notifying the relevant messaging provider of potential issues with message enqueueing and/or forwarding.

In yet another illustrative example, the route modification request may specify desired values of respective one or more parameters of the pricing model thus notifying the relevant messaging provider of available messaging traffic that would be allocated to that message routing provider should the pricing model be modified to implement the pricing parameter values communicated by the route modification request.

In situations in which the systems discussed here collect personal information about users, or may make use of personal information, the users may be provided with an opportunity to control whether the communication services platform 110 collects user information, or to control whether and/or how to receive content from the communication services platform 110 that may be more relevant to the user. In addition, certain data may be treated in one or more ways before it is stored or used, so that personally identifiable information is removed. For example, a user's identity may be treated so that no personally identifiable information may be determined for the user, or a user's geographic location may be generalized where location information is obtained (such as to a city, ZIP code, or state level), so that a particular location of a user cannot be determined. Thus, the user may have control over how information is collected about the user and used by the communication services platform 110.

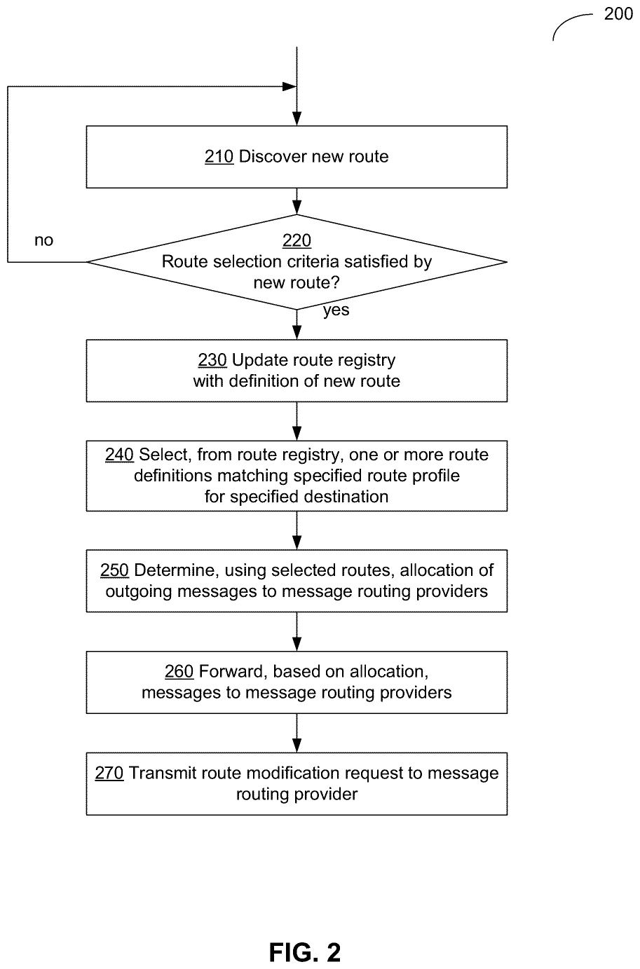

Elements of FIG. 1 are used with respect to FIGS. 2-4 to help describe various aspects and features of the communication services platform 110.

FIG. 2 is a flow diagram of an example method 200 of route discovery and management, in accordance with aspects of the present disclosure. The method 200 may be performed for each destination network that is served by the communication services platform. The method 200 may be performed by processing logic that may include hardware (e.g., processing device, circuitry, dedicated logic, programmable logic, microcode, hardware of a device, integrated circuit, etc.), software (e.g., instructions run or executed on a processing device), or a combination thereof. In some implementations, the method 200 is performed by the one or more modules (e.g., route discovery and management module 128) of the communication services platform 110 of FIG. 1. Although shown in a particular sequence or order, unless otherwise specified, the order of the operations may be modified. Thus, the illustrated implementations should be understood only as examples, and the illustrated operations may be performed in a different order, while some operations may be performed in parallel. Additionally, one or more operations may be omitted in some implementations. Thus, not all illustrated operations are required in every implementation, and other process flows are possible.

At operation 210, the processing logic implementing the method discovers a new route for forwarding messages to a specified destination network. In an illustrative example, route discovery may be facilitated by a provider-facing route registration portal maintained by the communication services platform, through which a message routing provider may submit a route definition for the new route. In an illustrative example, the route definition may be received, via a provider-facing route registration API maintained by the communication services platform, through which a message routing provider may submit a route definition for the new route. The route definition may include capabilities and/or parameters of the route.

In an illustrative example, route discovery may be triggered responsive to receiving a route discovery command via a user interface (UI). In another illustrative example, route discovery may be performed periodically at predefined or dynamically configurable time intervals. In yet another illustrative example, route discovery may be triggered automatically responsive to receiving a notification from the routing module 126 of lack of suitable routes to a specified destination that would meet the customers objective(s) in one or more aspects, such as deliverability, latency, throughput, etc.

In some implementations, route discovery may involve transmitting to one or more message routing providers, a route discovery request specifying one or more values of respective route parameters based on a set of route selection criteria.

At operation 220, the processing logic determines whether the new route satisfies one or more route selection criteria. The route selection criteria may include, e.g., performance criteria and/or quality criteria, which may specify the route capabilities and/or values of one or more parameters of the route. The route capabilities may specify the types of messages that may be forwarded over the route (e.g., SMS, MMS, electronic mail messages, voice mail messages, etc.). The route parameters may characterize the number of hops, deliverability, latency, throughput, pricing model, etc.

In some implementations, the route capabilities and parameters are confirmed by automated validation and testing procedures, which may involve forwarding, over the new route, at least a predefined number of test messages within one or more specified time windows and determining, e.g., the values of a chosen deliverability metric (e.g., conversion rate) latency, and/or other parameters. In automated testing scenarios, the values of the parameters of the route may be determined based on the feedback received from client devices that act as recipients of the test messages. In some implementations, the feedback is provided by a message receipt notification that is automatically sent by a client device to the validation and testing module 124 upon receiving a test message delivered by the communication services platform to the client device.

In some implementations, the validation and testing may involve exploratory use of the new route, by allocating to the new route a certain (e.g., not exceeding a predefined value, such as 5%) share of messages forwarded by the communication services platform on behalf of its customers. In exploratory use scenarios, the feedback is provided by an end user performing a certain action, e.g., submitting to a predefined website a one-time authentication token contained by a message delivered by the communication services platform to the client device operated by the user.

In some implementations, the exploratory use of the new route is only performed upon successfully completing automated validating and testing of the new route. Successful completion of the new route may be achieved if the parameter values produced by the automated testing procedures satisfy a predefined set of route selection criteria.

Responsive to determining, at operation 220, that the new route satisfies the route selection criteria, the processing continues at operation 230; otherwise, the processing loops back to operation 210.

At operation 230, the processing logic appends a definition of the new route to a route registry. The information stored by the route registry may include the destination network, the capabilities and parameters of the route, the pricing model, and/or other relevant information.

At operation 240, the processing logic selects, from the route registry, one or more routes (including the newly added route) that match a specified route profile for a specified destination. A route profile may include a set of requirements which a route should satisfy in order to match the profile, which may be associated, e.g., with a use case. The set of requirements may include, e.g., route capabilities (e.g., SMS delivery), threshold parameter values (such as the maximum number of hops) and/or performance or quality metric thresholds (such as deliverability, latency, throughput, etc.). In an illustrative example, the route definitions may be retrieved from the route registry by operation 240 in response to receiving one or more messages to be forwarded to the specified destination.

At operation 250, the processing logic determines, based on the one or more routes selected by operation 240, an allocation of one or more outgoing messages to respective routing providers. In some implementations, the allocation of outgoing messages to message routing providers is chosen to yield a maximum value of a chosen message delivery metric (e.g., the conversion rate). In some implementations, the allocation of outgoing messages to message routing providers is specified by a plurality of provider weights, such that each provider weight represents the share of messages to be routed by a corresponding message routing provider.

At operation 260, the processing logic forwards one or more messages to respective message routing providers based on the allocation of outgoing messages determined at operation 250.

At operation 270, the processing logic transmits a route modification request to the message routing provider associated with a particular route. The route modification request may specify desired threshold values of respective one or more specified parameters of the route, as described in more detail herein above.

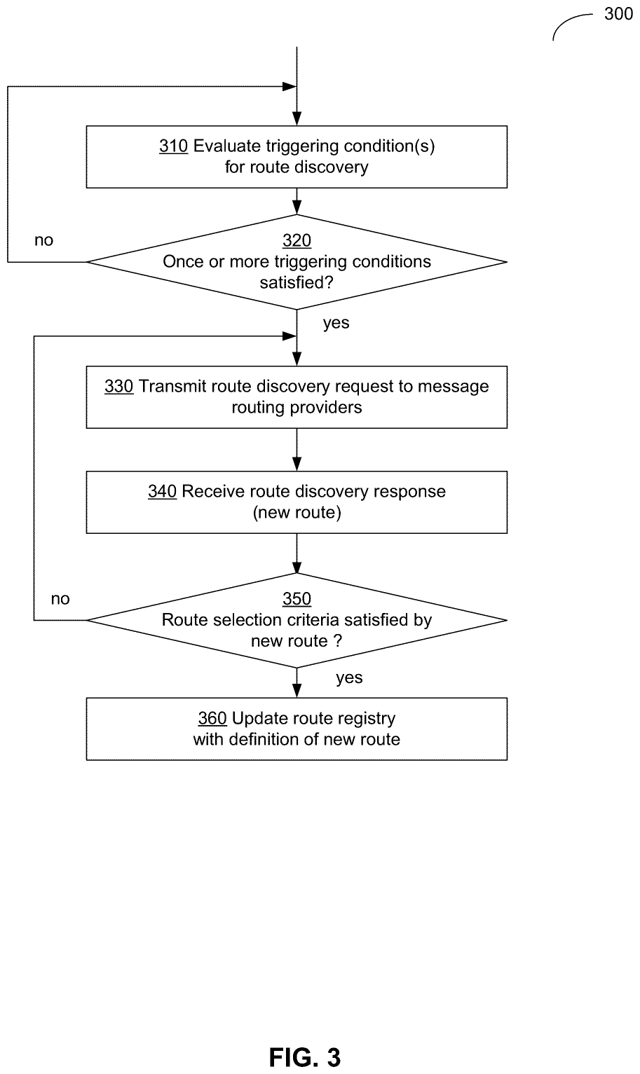

FIG. 3 is a flow diagram of an example method 300 of active route discovery, in accordance with aspects of the present disclosure. The method 300 may be performed for each destination network that is served by the communication services platform. The method 300 may be performed by processing logic that may include hardware (e.g., processing device, circuitry, dedicated logic, programmable logic, microcode, hardware of a device, integrated circuit, etc.), software (e.g., instructions run or executed on a processing device), or a combination thereof. In some implementations, the method 300 is performed by the one or more modules (e.g., route discovery and management module 128) of the communication services platform 110 of FIG. 1. Although shown in a particular sequence or order, unless otherwise specified, the order of the operations may be modified. Thus, the illustrated implementations should be understood only as examples, and the illustrated operations may be performed in a different order, while some operations may be performed in parallel. Additionally, one or more operations may be omitted in some implementations. Thus, not all illustrated operations are required in every implementation, and other process flows are possible.

At operation 310, the processing logic implementing the method evaluates one or more route discovery conditions. In an illustrative example, a route discovery condition may be satisfied responsive to receiving a route discovery command via a user interface (UI) or an application programming interface (API). In another illustrative example, a route discovery condition may be satisfied responsive to expiration of a predefined time period since the most recent route had been discovered for a specified destination. In another illustrative example, a route discovery condition may be satisfied responsive to failing to produce an allocation of outgoing messages to existing routes that would satisfy a particular set of customer requirements (e.g., defined by the cost, latency, message conversion rate, and/or other parameters).

Responsive to determining, at operation 320, that one or more route discovery conditions are satisfied, the processing continues at operation 330; otherwise, the processing loops back to operation 310.

At operation 330, the processing logic transmits, to one or more message routing providers, a route discovery request for a specified destination. In some implementations, the route discovery request may specify the desired capabilities and parameters of the route (e.g., deliverability, latency, throughput, etc.). In an illustrative example, the route discovery request may be transmitted via a provider-facing route registration API exposed by the communication services platform. In an illustrative example, the route discovery request may be transmitted via a provider-facing route registration portal, through which message routing providers may communicate the route capabilities and/or parameters to the communication services platform, as described in more detail herein below.

At operation 340, the processing logic receives a route discovery response, which may include a description of a new route.

At operation 350, the processing logic determines whether the new route satisfies one or more route selection criteria. The route selection criteria may include, e.g., performance criteria and/or quality criteria, which may specify the route capabilities and/or values of one or more parameters of the route, as described in more detail herein above.

Responsive to determining, at operation 350, that the new route satisfies the route selection criteria, the processing continues at operation 360; otherwise, the processing loops back to operation 330.

At operation 360, the processing logic appends a definition of the new route to a route registry. The information stored by the route registry may include the destination network, the capabilities and parameters of the route, the pricing model, and/or other relevant information, as described in more detail herein above.

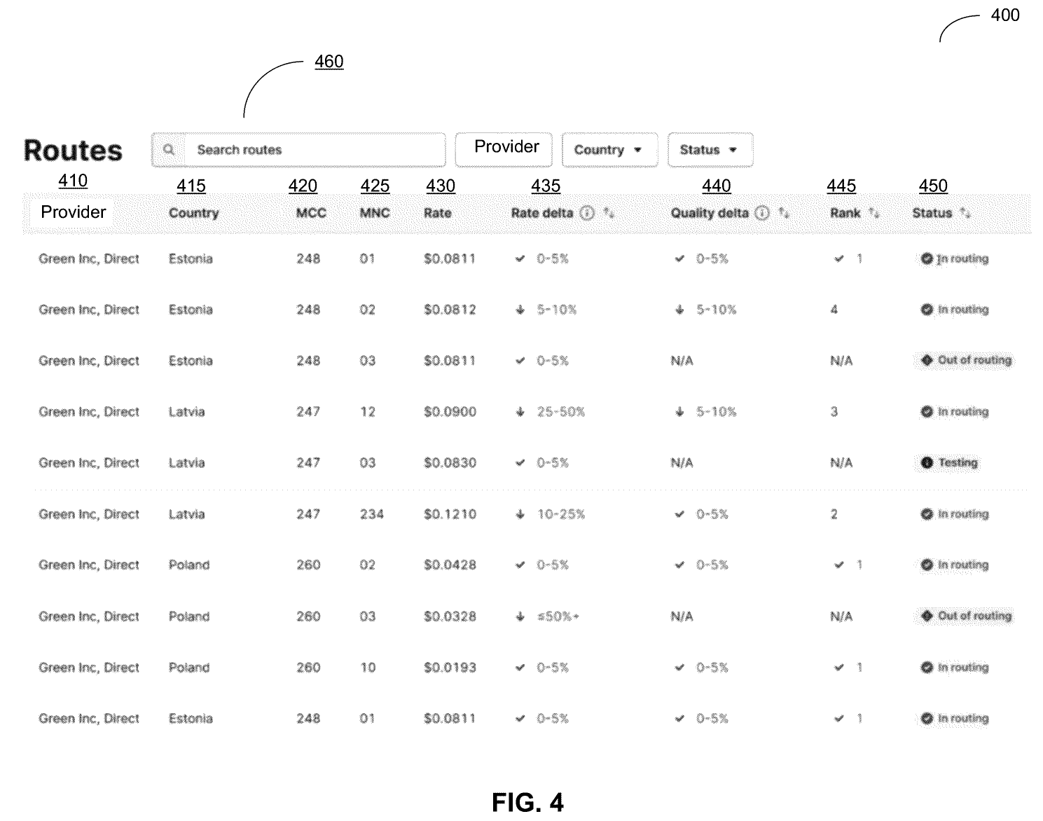

FIG. 4 schematically illustrates an example graphical user interface (GUI) that may be implemented by a provider-facing route registration portal, implemented in accordance with one or more aspects of the present disclosure. As schematically illustrated by FIG. 4, example GUI 400 may display a list of routes, which may be selected and/or sorted by message routing provider, country, and/or MCC/MNC tuple. For each route, the GUI 400 may display the message routing provider 410, the country 415, the MCC/MNC tuple 420-425, the message delivery rate (e.g., per-message delivery price) 430, the rate delta (i.e., the difference between the rate offered by this provider over this route and the chosen statistical metric, such as median, of rates of all available routes to the same destination) 435, the quality delta (i.e., the difference between the value of a chosen quality metric exhibited by this provider over this route and the chosen statistical metric, such as median, of all values of the chosen quality metric computed over all available routes to the same destination) 440, the rank of the route 445 (e.g., computed based on a combination of a chosen quality metric, the rate, and/or the throughput of the route), and the status of the route 450 (e.g., active (in routing), inactive (out of routing), or testing).

In some implementations, example GUI 400 may implement a search interface 460 allowing to search routes by a specified combination of message routing provider, country, and/or MCC/MNC tuple.

In some implementations, example GUI 400 may display additional information related to a displayed route (e.g., responsive to detecting a double-click event while the cursor selects a particular route). The additional information may include route capabilities, connectivity type, registration requirements, etc.

In some implementations, example GUI 400 may advertise additional traffic opportunities (i.e., new destinations) for a particular message routing provider. In an illustrative example, a route registration request directed to a particular message routing provider may specify the destination, the desired throughput, and/or the desired maximum rate (e.g., per-message delivery price), thus inviting the message routing provider to submit new route definitions.

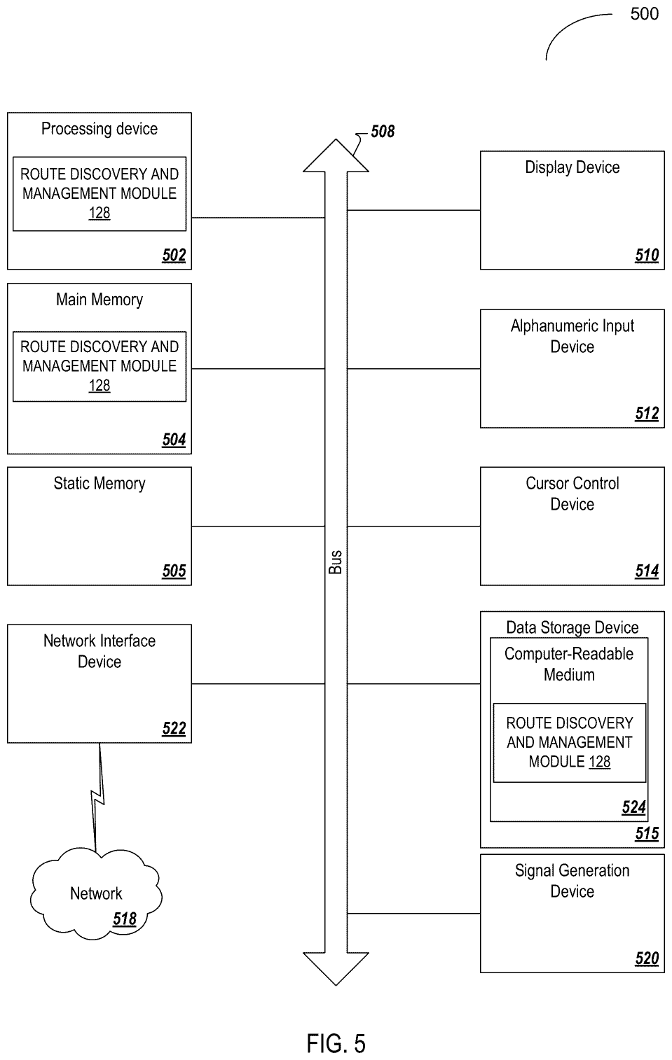

FIG. 5 is a block diagram illustrating an exemplary computer system 500, in accordance with an implementation of the disclosure. The computer system 500 executes one or more sets of instructions that cause the machine to perform any one or more of the methodologies discussed herein. Set of instructions, instructions, and the like may refer to instructions that, when executed by computer system 500, cause computer system 500 to perform one or more operations of one or more modules (e.g., route discovery and management module 128) of the communication services platform 110 of FIG. 1. The machine may operate in the capacity of a server or a client device in a client-server network environment, or as a peer machine in a peer-to-peer (or distributed) network environment. The machine may be a personal computer (PC), a tablet PC, a set-top box (STB), a personal digital assistant (PDA), a mobile telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute the sets of instructions to perform any one or more of the methodologies discussed herein.

The computer system 500 includes a processing device 502, a main memory 504 (e.g., read-only memory (ROM), flash memory, dynamic random access memory (DRAM) such as synchronous DRAM (SDRAM) or Rambus DRAM (RDRAM), etc.), a static memory 505 (e.g., flash memory, static random access memory (SRAM), etc.), and a data storage device 515, which communicate with each other via a bus 508.

The processing device 502 represents one or more general-purpose processing devices such as a microprocessor, central processing unit, or the like. More particularly, the processing device 502 may be a complex instruction set computing (CISC) microprocessor, reduced instruction set computing (RISC) microprocessor, very long instruction word (VLIW) microprocessor, or a processing device implementing other instruction sets or processing devices implementing a combination of instruction sets. The processing device 502 may also be one or more special-purpose processing devices such as an application specific integrated circuit (ASIC), a field programmable gate array (FPGA), a digital signal processor (DSP), network processor, or the like. The processing device 502 is configured to execute instructions of one or more modules (e.g., route discovery and management module 128) of the communication services platform 110 of FIG. 1 for performing the operations discussed herein.

The computer system 500 may further include a network interface device 522 that provides communication with other machines over a network 518, such as a local area network (LAN), an intranet, an extranet, or the Internet. The computer system 500 also may include a display device 510 (e.g., a liquid crystal display (LCD) or a cathode ray tube (CRT)), an alphanumeric input device 512 (e.g., a keyboard), a cursor control device 514 (e.g., a mouse), and a signal generation device 520 (e.g., a speaker).

The data storage device 515 may include a non-transitory computer-readable storage medium 524 on which is stored the sets of instructions of one or more modules (e.g., route discovery and management module 128) of the communication services platform 110 of FIG. 1 implementing the methods described herein. The sets of instructions of one or more modules (e.g., route discovery and management module 128) of the communication services platform 110 of FIG. 1 may also reside, completely or at least partially, within the main memory 504 and/or within the processing device 502 during execution thereof by the computer system 500, the main memory 504 and the processing device 502 also constituting computer-readable storage media. The sets of instructions may further be transmitted or received over the network 518 via the network interface device 522.

While the example of the computer-readable storage medium 624 is shown as a single medium, the term “computer-readable storage medium” may include a single medium or multiple media (e.g., a centralized or distributed database, and/or associated caches and servers) that store the sets of instructions. The term “computer-readable storage medium” may include any medium that is capable of storing, encoding or carrying a set of instructions for execution by the machine and that causes the machine to perform any one or more of the methodologies of the disclosure. The term “computer-readable storage medium” may include, but not be limited to, solid-state memories, optical media, and magnetic media.

In the foregoing description, numerous details are set forth. It will be apparent, however, to one of ordinary skill in the art having the benefit of this disclosure, that the disclosure may be practiced without these specific details. In some instances, well-known structures and devices are shown in block diagram form, rather than in detail, in order to avoid obscuring the disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It may be borne in mind, however, that all of these and similar terms are to be associated with the appropriate physical quantities and are merely convenient labels applied to these quantities. Unless specifically stated otherwise, it is appreciated that throughout the description, discussions utilizing terms such as “authenticating”, “providing”, “receiving”, “identifying”, “determining”, “sending”, “enabling” or the like, refer to the actions and processes of a computer system, or similar electronic computing device, that manipulates and transforms data represented as physical (e.g., electronic) quantities within the computer system memories or registers into other data similarly represented as physical quantities within the computer system memories or registers or other such information storage, transmission or display devices.

The disclosure also relates to an apparatus for performing the operations herein. This apparatus may be specially constructed for the required purposes, or it may include a general purpose computer selectively activated or reconfigured by a computer program stored in the computer. Such a computer program may be stored in a computer readable storage medium, such as, but not limited to, any type of disk including a floppy disk, an optical disk, a compact disc read-only memory (CD-ROM), a magnetic-optical disk, a read-only memory (ROM), a random access memory (RAM), an erasable programmable read-only memory (EPROM), an electrically erasable programmable read-only memory (EEPROM), a magnetic or optical card, or any type of media suitable for storing electronic instructions.

The words “example” or “exemplary” are used herein to mean serving as an example, instance, or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims may generally be construed to mean “one or more” unless specified otherwise or clear from context to be directed to a singular form. Moreover, use of the term “an implementation” or “one implementation” or “an implementation” or “one implementation” throughout is not intended to mean the same implementation or implementation unless described as such. The terms “first,” “second,” “third,” “fourth,” etc. as used herein are meant as labels to distinguish among different elements and may not necessarily have an ordinal meaning according to their numerical designation.

For simplicity of explanation, methods herein are depicted and described as a series of acts or operations. However, acts in accordance with this disclosure may occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

In additional implementations, one or more processing devices for performing the operations of the above described implementations are disclosed. Additionally, in implementations of the disclosure, a non-transitory computer-readable storage medium stores instructions for performing the operations of the described implementations. Also in other implementations, systems for performing the operations of the described implementations are also disclosed.

It is to be understood that the above description is intended to be illustrative, and not restrictive. Other implementations will be apparent to those of skill in the art upon reading and understanding the above description. The scope of the disclosure may, therefore, be determined with reference to the appended claims, along with the full scope of equivalents to which such claims are entitled.

What is claimed is:

1. A method, comprising:
discovering, by a processing device, a new route for forwarding messages to a specified destination network;
responsive to determining that the new route satisfies one or more performance criteria, appending a definition of the new route to a route registry associated with the specified destination network;
selecting, from the route registry, one or more routes matching a specified route profile, wherein the one or more routes comprise the new route; and
determining, using the one or more routes, an allocation of outgoing messages to message routing providers.

2. The method of claim 1, further comprising:
forwarding the one or more messages to respective message routing providers based on the allocation of outgoing messages to message routing providers.

3. The method of claim 1, wherein discovering the new route further comprises:
receiving the definition of the new route via a provider-facing route registration portal.

4. The method of claim 1, wherein performing discovering the new route further comprises:
receiving the definition of the new route via a route registration application programming interface (API).

5. The method of claim 1, wherein discovering the new route further comprises:
transmitting, to one or more message routing providers, a route discovery request specifying one or more values of respective route parameters based on the one or more performance criteria.

6. The method of claim 1, wherein discovering the new route is performed responsive to determining that a route discovery triggering condition is satisfied.

7. The method of claim 1, wherein determining that the new route satisfy one or more performance criteria further comprises:
performing at least one of: validation of the new route or testing of the new route.

8. The method of claim 1, further comprising:
transmitting, to a message routing provider associated with a route, a route modification request, the route modification request specifying a desired threshold value of a specified parameter of the route.

9. The method of claim 1, wherein the allocation of outgoing messages to message routing providers yields a maximum value of a chosen message delivery metric.

10. A system, comprising:
a memory; and
a processing device, coupled to the memory, the processing device configured to:
discover a new route for forwarding messages to a specified destination network;
responsive to determining that the new route satisfies one or more performance criteria, append a definition of the new route to a route registry associated with the specified destination network;
select, from the route registry, one or more routes matching a specified route profile, wherein the one or more routes comprise the new route; and
determine, using the one or more routes, an allocation of outgoing messages to message routing providers.

11. The system of claim 10, wherein the processing device is further configured to:
forward the one or more messages to respective message routing providers based on the allocation of outgoing messages to message routing providers.

12. The system of claim 10, wherein discovering the new route further comprises:
receiving the definition of the new route via at least one of: a provider-facing route registration portal or a route registration application programming interface (API).

13. The system of claim 10, wherein discovering the new route further comprises:
transmitting, to one or more message routing providers, a route discovery request specifying one or more values of respective route parameters based on the one or more performance criteria.

14. The system of claim 10, wherein the processing device is further configured to:
transmit, to a message routing provider associated with a route, a route modification request, the route modification request specifying a desired threshold value of a specified parameter of the route.

15. The system of claim 10, wherein determining that the new route satisfy one or more performance criteria further comprises:
performing at least one of: validation of the new route or testing of the new route.

16. A non-transitory computer-readable storage medium comprising executable instructions that, responsive to execution by a processing device, cause the processing device to:
discover a new route for forwarding messages to a specified destination network;
responsive to determining that the new route satisfies one or more performance criteria, append a definition of the new route to a route registry associated with the specified destination network;
select, from the route registry, one or more routes matching a specified route profile, wherein the one or more routes comprise the new route; and
determine, using the one or more routes, an allocation of outgoing messages to message routing providers.

17. The non-transitory computer-readable storage medium of claim 16, further comprising executable instructions that, responsive to execution by the processing device, cause the processing device to:
forward the one or more messages to respective message routing providers based on the allocation of outgoing messages to message routing providers.

18. The non-transitory computer-readable storage medium of claim 16, wherein discovering the new route further comprises:
receiving the definition of the new route via at least one of: a provider-facing route registration portal or a route registration application programming interface (API).

19. The non-transitory computer-readable storage medium of claim 16, wherein discovering the new route further comprises:
transmitting, to one or more message routing providers, a route discovery request specifying one or more values of respective route parameters based on the one or more performance criteria.

20. The non-transitory computer-readable storage medium of claim 16, executable instructions that, responsive to execution by the processing device, cause the processing device to:
transmit, to a message routing provider associated with a route, a route modification request, the route modification request specifying a desired threshold value of a specified parameter of the route.
